(19) United States
(12) Patent Application Publication
(10) Pub. No.: US 2013/0215045 A1
(43) Pub. Date: Aug. 22, 2013

(54) STROKE DISPLAY METHOD OF HANDWRITING INPUT AND ELECTRONIC DEVICE

(71) Applicant: Chun-Yu Chen, New Taipei City (TW)

(72) Inventor: Chun-Yu Chen, New Taipei City (TW)

(73) Assignee: WISTRON CORPORATION, New Taipei City (TW)

(21) Appl. No.: 13/463,823

(22) Filed: May 4, 2012

(30) Foreign Application Priority Data
Feb. 17, 2012 (TW) 101105315

(51) Int. Cl. G06F 3/041

(52) U.S. Cl. 345/173

(57) ABSTRACT

A stroke display method of handwriting input and an electronic device are provided. In the method, a selection of a specific script style comprising multiple common strokes is received. When a touch is detected, an initial touch point is obtained. While the touch is not terminated, a latest touch point is obtained continuously, and a moving direction is determined by the initial touch point and the latest touch point. Once the touch is terminated or the moving direction is changed, whether a trajectory of the touch consists with any of the common strokes is determined. If yes, at least one patch point is determined according to the initial touch point, the latest touch point, and the consisted common stroke. A closed graph is established by using the initial touch point, the latest touch point, and the at least one patch point, and is displayed on a display module.

### CROSS-REFERENCE TO RELATED APPLICATION

This application claims the priority benefit of Taiwan application serial no. 101105315, filed on Feb. 17, 2012. The entirety of the above-mentioned patent application is hereby incorporated by reference herein and made a part of this specification.

### BACKGROUND OF THE INVENTION

1. Field of the Invention

The invention relates to a handwriting input application of an electronic device. Particularly, the invention relates to a stroke display method of handwriting input and an electronic device using the same.

2. Description of Related Art

Along with rapid development and wide application of information technology, wireless communication and information home appliances, input devices of operation interfaces of many information products have been changed from conventional keyboards and mice to touch screens. The touch screen may also serve as an input and output interface of the information product. Namely, the user may not only view an operation frame through the touch screen, but may also input text or instructions through the touch screen to operate the information product.

Handwriting input is an input method developed based on the touch screen. Since a display speed of the touch screen and a processor speed of the product become faster, a user can conveniently and quickly input various characters on the touch screen through a handwriting input function. However, regarding the current information products in the market that support the handwriting input function, during a writing process of the user, the touch screen can only display lines consist with an input trajectory, and cannot adjust an appearance of the input trajectory.

### SUMMARY OF THE INVENTION

The invention is directed to a stroke display method of handwriting input and an electronic device using the same, by which an appearance of an input trajectory is capable of being adjusted while a user performs the handwriting input, so as to present an elegant character.

The invention provides a stroke display method of handwriting input, which is adapted to an electronic device having a touch input module and a display module. In the method, a selection of a specific script style comprising a plurality of common strokes is received. When a touch is detected by a touch input module, a corresponding initial touch point is obtained. While the touch is not terminated, a latest touch point is obtained continuously, and a moving direction is determined according to the initial touch point and the latest touch point. Once the touch is terminated or the moving direction is changed, whether a trajectory of the touch consists with a specific stroke in the common strokes is determined according to the moving direction before changing. If yes, at least one patch point is determined according to the specific stroke, the initial touch point and the latest touch point, and a closed graph is established by using the initial touch point, the latest touch point, and the at least one patch point, and the closed graph is displayed on a display module.

According to another aspect, the invention provides an electronic device including a touch input module, a display module and a processing unit. The touch input module includes a touch panel and a touch controller coupled to each other, and the display module includes a display panel and a display controller coupled to each other. The processing unit is coupled to the touch controller and the display controller. The processing unit receives a selection of a specific script style comprising a plurality of common strokes. When the touch panel detects a touch, the processing unit obtains a corresponding initial touch point through the touch controller, and continuously obtains a latest touch point of the touch while the touch is not terminated, and determines a moving direction according to the initial touch point and the latest touch point. Once the touch is terminated or the moving direction is changed, the processing unit determines whether a trajectory of the touch consists with a specific stroke in the common strokes according to the moving direction before changing. If yes, the processing unit determines at least one patch point according to the specific stroke, the initial touch point and the latest touch point, and establishes a closed graph by using the initial touch point, the latest touch point, and the at least one patch point, and controls the display controller to display the closed graph on the display panel.

According to the above descriptions, when it is detected that the user performs the handwriting input through the touch input module, an appearance of the input stroke is adjusted according to the common strokes of the selected specific script style, and the adjusted result is presented on the display panel. In this way, the user can enjoy the beautified character while performing the input, so as to improve a fun of using the electronic device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the invention.

FIG. 2 is a flowchart illustrating a stroke display method of handwriting input.

FIG. 3 is a schematic diagram of eight common strokes of the Eight Principles of Yong.

FIG. 4 is a corresponding table of preset directions and the eight common strokes included in the Eight Principles of Yong according to an embodiment of the invention.

FIG. 5 is a flowchart illustrating a method for determining a moving direction according to an embodiment of the invention.

FIG. 6 is a schematic diagram of a patch point obtained when a trajectory of a touch corresponds to a common stroke of “sideway” according to an embodiment of the invention.

FIG. 7 is a schematic diagram of patch points obtained when a trajectory of a touch corresponds to a common stroke of “bridle” or “horsewhip” according to an embodiment of the invention.

FIG. 8 is a schematic diagram of patch points obtained when a trajectory of a touch corresponds to a common stroke of “strive” according to an embodiment of the invention.

FIG. 9 is a schematic diagram of a patch point obtained when a trajectory of a touch corresponds to a common stroke of “jump” according to an embodiment of the invention.

FIG. 10 is a schematic diagram of a patch point obtained when a trajectory of a touch corresponds to a common stroke of “passing lightly” according to an embodiment of the invention.

FIG. 11 is a schematic diagram of a patch point obtained when a trajectory of a touch corresponds to a common stroke of “pecking” according to an embodiment of the invention.

FIG. 12 is a schematic diagram of a patch point obtained when a trajectory of a touch corresponds to a common stroke of “dismemberment” according to an embodiment of the invention.

FIG. 13A is a schematic diagram of a trajectory of a handwriting input before adjustment according to an embodiment of the invention.

FIG. 13B is a schematic diagram of a trajectory of a handwriting input after the aforementioned adjustment according to an embodiment of the invention.

### DETAILED DESCRIPTION OF DISCLOSED EMBODIMENTS

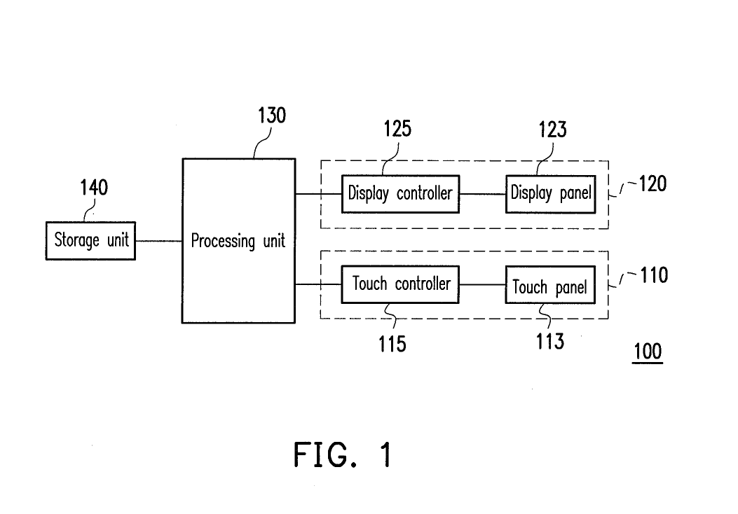

FIG. 1 is a block diagram of an electronic device according to an embodiment of the invention. Referring to FIG. 1, the electronic device 100 includes a touch input module 110, a display module 120, a processing unit 130 and a storage unit 140. The electronic device 100 of the present embodiment may be a mobile phone, a personal digital assistant, a smart phone, an E-book, a game machine, a flat panel computer (tablet PC), etc., which is not limited by the invention.

The touch input module 110 includes a touch panel 113 and a touch controller 115 coupled to each other, where the touch controller 115 is coupled to the processing unit 130. The touch panel 113 may be a resistive touch panel, a capacitive touch panel, an optical touch panel, an acoustic wave touch panel, an electromagnetic touch panel, etc., which is not limited by the invention. The touch controller 115 may be an embedded controller (EC). The touch panel 113 receives a touch operation from the user, and the touch controller 115 transmits position information (for example, the coordinate values of the touch point) of the touch operation to the processing unit 130, and the processing unit 130 generates a corresponding operation result.

The display module 120 includes a display panel 123 and a display controller 125 coupled to each other, where the display controller 125 is coupled to the processing unit 130. The display panel 123 is, for example, a liquid crystal display (LCD) panel, and the display controller 125 is, for example, a visual processing unit (VPU). In detail, the processing unit 130 writes frame data (for example, colors of pixels of the display panel 123) required to be output according to the user's operation or the system operation into a register, and the display controller 125 is controlled by the processing unit 130 to read the data stored in the register, and displays the data on the display panel 123.

In an embodiment, the touch panel 113 is attached to a surface of the display panel 123 to form a touch screen. The touch screen has both functions of receiving touch inputs and displaying images.

The processing unit 130 is, for example, a central processing unit (CPU), which is in charge of a whole operation of the electronic device 100. In detail, the processing unit 130 executes an operating system loaded to the storage unit 140, so that the user can interact with the electronic device 100 through the operating system.

The storage unit 140 includes a memory, for example, a dynamic random access memory (DRAM) or a static random access memory (SRAM), etc. The storage unit 140 may further include a hard disk, an optical disk or an external storage device (for example, a memory card and a flash drive, etc.). The type of the storage unit 140 is not limited by the invention. The storage unit 140 may load various programs (for example, the operating system and driving programs, etc.) and data to facilitate execution and utilization of the processing unit 130. In the present embodiment, the storage unit 140 further stores information of a plurality of script styles (e.g., the font file of each script style), and the user can select a desired script style when establishing a document. Information of the common strokes corresponding to each of the script styles is also stored in the storage unit 140.

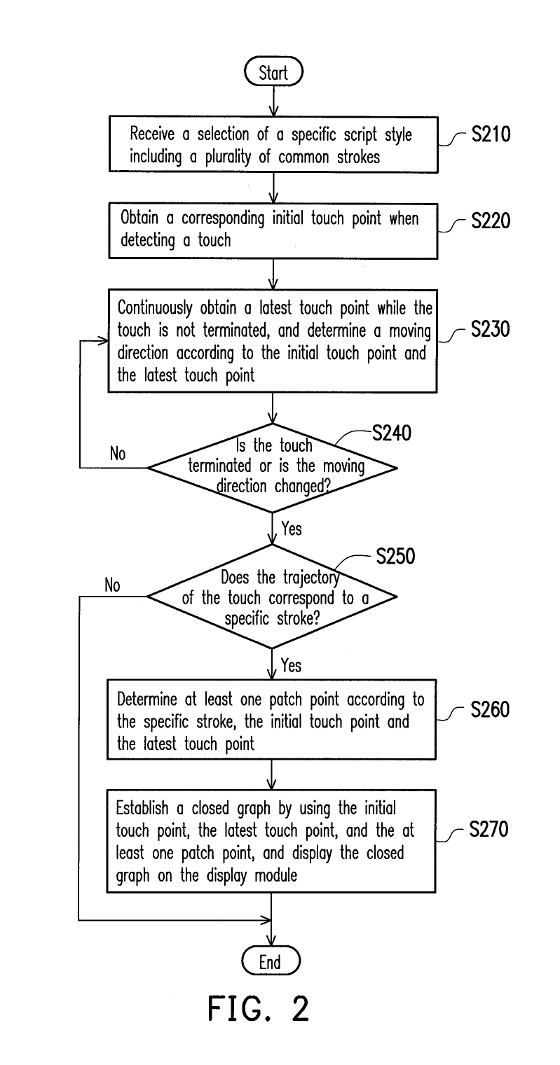

In the present embodiment, when the user performs a handwriting input through the touch input module 110, the processing unit 130 can beautify a stroke of the handwriting input according to the pre-selected script style, and presents a beautified result through the display module 120. To further describe an operation method of the electronic device 100, another embodiment is provided below for descriptions. FIG. 2 is a flowchart illustrating a stroke display method of handwriting input.

Referring to FIG. 1 and FIG. 2, in step S210, a selection of a specific script style is received, where the specific script style includes a plurality of common strokes. For example, when the user edits a file, writes an email, uses instant messaging software, or uses various application programs that require to receive character input, the user can select a specific script style from all of the script styles supported by the electronic device 100, for example, when the input language is Chinese, the specific script style can be a Regular script in Chinese (i.e., the Kaiti style), a Mingti style, a handwriting style or an art style, etc., though the invention is not limited thereto. Moreover, the script styles that can be selected by the user are different according to different input languages.

Then, in step S220, when the touch panel 113 in the touch input module 110 initially detects a touch, the processing unit 130 obtains a corresponding initial touch point. In detail, the touch controller 115 converts touch information detected by the touch panel 113 into coordinate values (including a horizontal coordinate value and a vertical coordinate value) to represent a touch point, and transmits the coordinate values to the processing unit 130.

In step S230, while the touch is not terminated (i.e. the touch panel 113 continuously detects the touch), the touch controller 115 keeps transmitting latest coordinate information to the processing unit 130 according to a current position of the touch, and the processing unit 130 continuously obtains a latest touch point. In the present embodiment, the processing unit 130 determines a moving direction of the touch input according to the initial touch point and the latest touch point. For example, the processing unit 130 determines whether the moving direction is one of a plurality of preset directions according to a horizontal difference between individual horizontal coordinate values of the initial touch point and the latest touch point, a vertical difference between individual vertical coordinate values of the initial touch point and the latest touch point, and a slope between the initial touch point and the latest touch point, where the preset directions correspond to the selected specific script style.

Then, in step S240, it is determined whether the touch is terminated or the moving direction is changed. If the touch is not terminated and the moving direction is not changed, the flow is returned to the step S230 to again obtain the latest touch point and re-determine the moving direction.

If a determination result of the step S240 is affirmative, it represent that a handwriting stroke is completed or the moving direction is changed, and in step S250, the processing unit 130 determines whether a trajectory of the touch consists with a specific stroke corresponding to the selected specific script style according to the moving direction before changing. In detail, the processing unit 130 obtains relationships between all of the common strokes corresponding to the specific script style and various preset directions from the storage unit 140. If the moving direction before changing approaches or consists with any of the preset directions, it represents that the trajectory of the touch consists with the common stroke corresponding to the preset direction.

If the determination result of the step S250 is negative, it represents that the processing unit 130 cannot identify the common stroke corresponding to the trajectory of the touch, and the flow of the method is ended.

If the determination result of the step S250 is affirmative, in step S260, the processing unit 130 determines at least one patch point according to the specific stroke, the initial touch point and the latest touch point. In detail, the storage unit 140 records a patch point template corresponding to each of the common strokes. The processing unit 130 obtains the patch point template corresponding to the specific stroke from the storage unit 140, and determines the number of the at least one patch point according to a shape of the patch point template, and then calculates coordinate information of each patch point according to the patch point template, and the horizontal coordinate values and the vertical coordinate values of the initial touch point and the latest touch point. In the present embodiment, each of the patch point template can be a closed geometric graph (for example, a triangle, a square, etc.) formed by a plurality of polylines, or a closed geometric graph (for example, a circle, an ellipse, etc.) formed by a curved line. The shape of each of the patch point templates corresponds to the selected specific script style.

Finally, in step S270, the processing unit 130 establishes a closed graph by using the initial touch point, the latest touch point, and the at least one patch point, and controls the display controller 125 to display the closed graph on the display panel 123. In detail, the processing unit 130 connects the initial touch point, the latest touch point and each patch point into a closed graph with a shape consisting with or similar to the patch point template according to a connecting sequence. In detail, the processing unit 130 writes information such as a position and a color of the closed graph into a frame buffer of a video memory (not shown), where a size of the frame buffer corresponds to a pixel number of the display panel 123. The display controller 125 reads data from the frame buffer and displays the data on the display panel 123.

As shown in FIG. 2, the handwriting stroke input through the touch input module 110 can be modified into a closed graph corresponding to the common strokes of the specific script style by the processing unit 130, and displayed by the display module 120. In this way, the trajectory of the handwriting input displayed on the display panel 123 is no longer a pure line, but presents a specific font effect.

In the following descriptions, the Regular script in Chinese serving as the specific script style is taken as an example to describe how the stroke display method of handwriting input of the invention beautifies the stroke of the handwriting input according to the Eight Principles of Yong for displaying on the display panel 123 when the user performs handwriting input of a Chinese character on the electronic device 100.

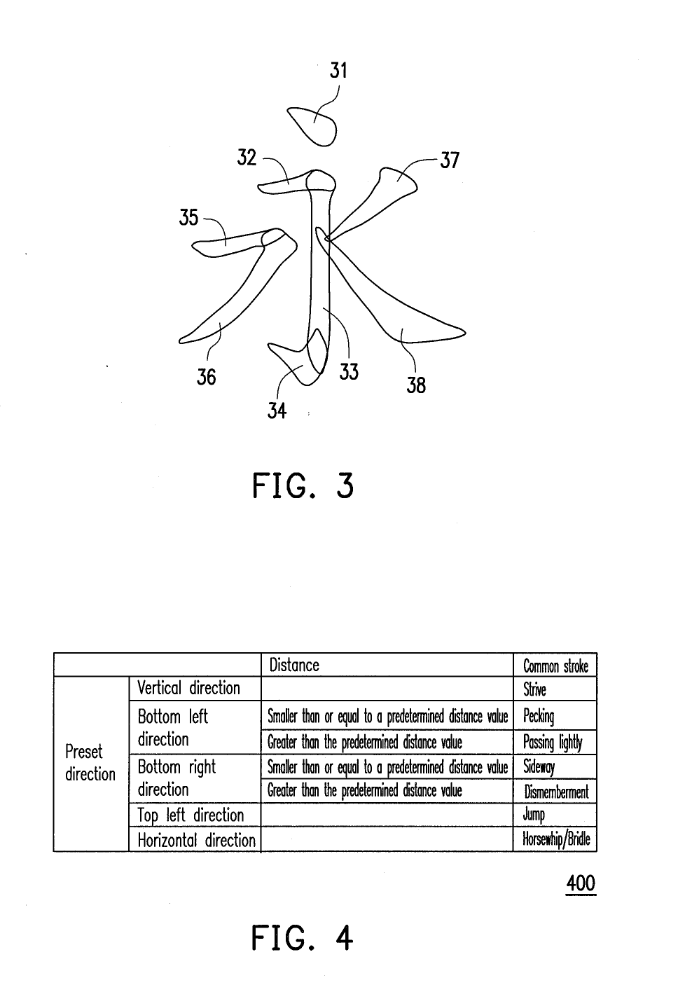

FIG. 3 is a schematic diagram of eight common strokes of the Eight Principles of Yong. Referring to FIG. 3, common strokes 31 to 38 respectively represent the eight common strokes (sideway, bridle, strive, jump, horsewhip, passing lightly, pecking and dismemberment) of the Eight Principles of Yong. Generally, the writing direction of the strokes of a Chinese character is usually from left to right, from top to bottom, from top right to bottom left and from top left to bottom right, and some other strokes have a turning towards specific directions. The eight common strokes of the Eight Principles of Yong are the same, and each of the common strokes corresponds to a preset writing direction (which is referred to as preset direction hereinafter)

FIG. 4 is a corresponding table of the preset directions and the eight common strokes included in the Eight Principles of Yong according to an embodiment of the invention. Referring to FIG. 3 and the corresponding table 400 of FIG. 4, a preset direction corresponding to the common stroke 31 (sideway) is a bottom right direction, a preset direction corresponding to the common stroke 32 (bridle) is a horizontal direction, a preset direction corresponding to the common stroke 33 (strive) is a vertical direction, a preset direction corresponding to the common stroke 34 (jump) is a top left direction, a preset direction corresponding to the common stroke 35 (horsewhip) is the horizontal direction, a preset direction corresponding to the common stroke 36 (passing lightly) is a bottom left direction, a preset direction corresponding to the common stroke 37 (pecking) is the bottom left direction, and a preset direction corresponding to the common stroke 38 (dismemberment) is the bottom right direction. It should be noticed that although the common stroke 36 (passing lightly) and the common stroke 37 (pecking) all correspond to the bottom left direction, referring to FIG. 3, it is known that the common stroke 36 passing lightly) is relatively long and the common stroke 37 (pecking) is relatively short. Moreover, although the common stroke 31 (sideway) and the common stroke 38 (dismemberment) all correspond to the bottom right direction, the common stroke 31 (sideway) is relatively short and the common stroke 38 (dismemberment) is relatively long. Moreover, a data structure recording the above corresponding relationship is not limited by the invention, and the corresponding relationship can be stored in the storage unit 140 in form of file, though the invention is not limited thereto.

According to the above descriptions, when the processing unit 130 determines whether the stroke of the handwriting input consists with one of the aforementioned eight common strokes, the determination is first performed according to the moving direction of the stroke. When the moving direction simultaneously corresponds to two common strokes, a stroke distance is used for distinguishing.

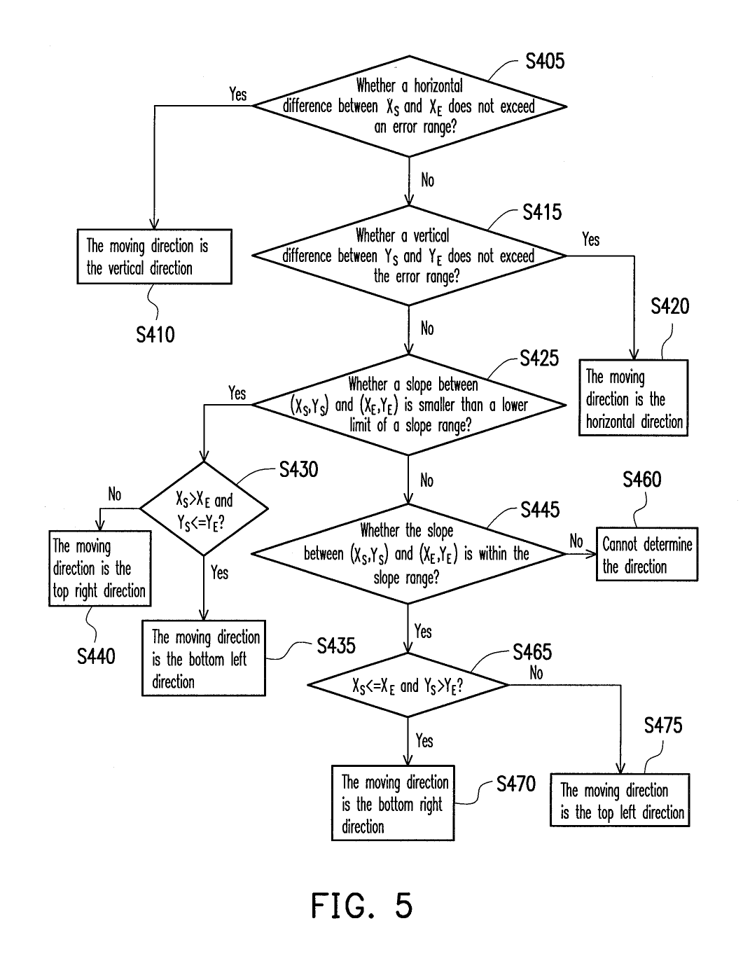

Details steps that the processing unit 130 determines the moving direction are described below with reference of FIG. 5. For simplicity's sake, two-dimensional coordinate values (X_{S}, Y_{S}) are used to represent an initial touch point S, two-dimensional coordinate values (X_{E}, Y_{E}) are used to represent a latest touch point E, and origin coordinate values (0, 0) of the two-dimensional coordinate system are at the upper left corner, where X_{S} is a horizontal coordinate value of the initial touch point S, Y_{S} is a vertical coordinate value of the initial touch point S, X_{E} is a horizontal coordinate value of the latest touch point E, Y_{E} is a vertical coordinate value of the latest touch point E.

Referring to FIG. 5, in step S405, the processing unit 130 determines whether a horizontal difference between the horizontal coordinate value X_{S} of the initial touch point S and the horizontal coordinate value X_{E} of the latest touch point E does not exceed an error range.

If the determination result of the step S405 is affirmative, it represents that the horizontal coordinate values of the two touch points are the same or close, and in step S410, the processing unit 130 determines that the moving direction is a vertical direction.

If the determination result of the step S405 is negative, as shown in step S415, the processing unit 130 determines whether a vertical difference between the vertical coordinate value Y_{S} of the initial touch point S and the vertical coordinate value Y_{E} of the latest touch point E does not exceed the error range.

If the determination result of the step S415 is affirmative, it represents that although the horizontal coordinate values of the two touch points exceeds the error range, but the vertical coordinate values of the two touch points are the same or close, and in step S420, the processing unit 130 determines that the moving direction is a horizontal direction.

If the determination result of the step S415 is negative, as shown in step S425, the processing unit 130 determines whether a slope between the initial touch point S and the latest touch point E is smaller than a lower limit of a slope range. In the present embodiment, the lower limit of the slope range is −0.5, and an upper limit of the slope range is, for example, 10, though the invention is not limited thereto.

If the determination result of the step S425 is affirmative, in step S430, it is determined whether the horizontal coordinate value X_{S} of the initial touch point S is greater than the horizontal coordinate value X_{E} of the latest touch point E, and whether the vertical coordinate value Y_{S} of the initial touch point S is smaller than or equal to the vertical coordinate value Y_{E} of the latest touch point E.

If the determination result of the step S430 is affirmative, in step S435, the processing unit 130 determines the moving direction to be the bottom left direction. If the determination result of the step S430 is negative, in step S440, the processing unit 130 determines the moving direction to be the top right direction.

Reviewing the step 425, if the determination result of the step S425 is negative, in step S445, the processing unit 130 determines whether the slope between the initial touch point S and the latest touch point E is within the slope range. If not, in step S460, the processing unit 130 cannot determine the moving direction, in other words, the trajectory of the handwriting input does not consist with any common stroke in the Regular script in Chinese.

However, if the slope is within the slope range, in step S465, the processing unit 130 determines whether the horizontal coordinate value X_{S} of the initial touch point S is smaller than or equal to the horizontal coordinate value X_{E} of the latest touch point E, and whether the vertical coordinate value Y_{S} of the initial touch point S is greater than the vertical coordinate value Y_{E} of the latest touch point E.

If the determination result of the step S465 is affirmative, in step S470, the processing unit 130 determines the moving direction to be the bottom right direction. If the determination result of the step S465 is negative, in step S475, the processing unit 130 determines the moving direction to be the top left direction.

As shown in FIG. 5, the processing unit 130 can determine whether the moving direction consists with one of the five preset directions of the vertical direction, the horizontal direction, the bottom left direction, the bottom right direction, or the top left direction by using the initial touch point and the latest touch point, and when the touch is terminated or the moving direction is changed, the processing unit 130 can determine whether the stroke of the current handwriting input corresponds to one of the eight common strokes of sideway, bridle, strive, jump, horsewhip, passing lightly, pecking and dismemberment according to the moving direction before changing and the corresponding table 400 of FIG. 4.

However, it should be noticed that the invention is not limited to the aforementioned flow for determining the moving direction. In other words, when the user selects other specific script styles or even other input languages, a determination criterion of the moving direction varies along with a character shape of the input language and a usual writing direction of the strokes.

How the processing unit 130 determines the number of the patch points and coordinate values of each patch point when the stroke of the handwriting input corresponds to a certain common stroke in the Eight Principles of Yong are described below. In the present embodiment, each common stroke in the Eight Principles of Yong corresponds to a polygon patch point template, and the processing unit 130 determines the number of the patch points required by the corresponding common stroke according to the number of vertices of each of the polygon patch point templates. For example, the polygon patch point templates corresponding to the common strokes “passing lightly”, “pecking”, “dismemberment”, “sideway” and “jump” are triangles, so that when the specific stroke corresponding to the trajectory of the handwriting input is “passing lightly”, “pecking”, “dismemberment”, “sideway” or “jump”, the processing unit 130 defines a single patch point. The polygon patch point templates corresponding to the common strokes “horsewhip”, “bridle” and “strive” are hexagons, so that when the specific stroke corresponding to the trajectory of the handwriting input is “horsewhip”, “bridle” or “strive”, the processing unit 130 defines a four patch points.

Besides, the processing unit 130 also determines the coordinate values of each patch point according to the horizontal/vertical coordinate values of the initial touch point and the latest touch points and a shape of the polygon patch point template.

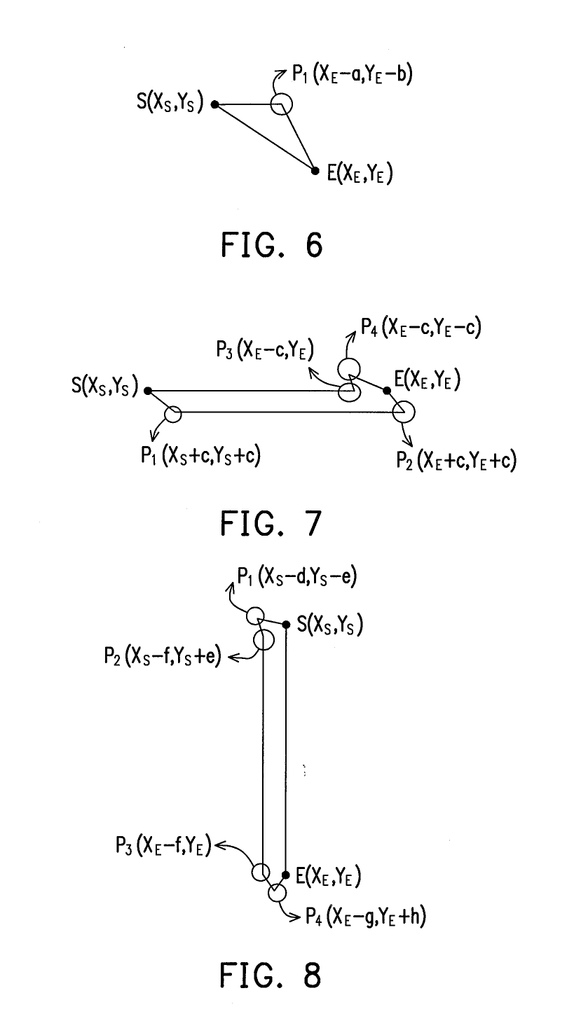

In detail, in case that the moving direction is the bottom right direction, and a distance between the initial touch point S and the latest touch point E is smaller than or equal to a predetermined distance value, the processing unit 130 determines that the specific stroke corresponding to the trajectory of the user's handwriting input is “sideway”, and FIG. 6 is a schematic diagram of a patch point obtained when the trajectory of the touch corresponds to the common stroke of “sideway” according to an embodiment of the invention. The processing unit 130 obtains a horizontal adjustment value a and a vertical adjustment value b corresponding to the common stroke of “sideway”. As shown in FIG. 6, the processing unit 130 selects the horizontal coordinate value X_{E} of the latest touch point E according to the common stroke of “sideway”, and performs a subtraction operation on the horizontal coordinate value X_{E} and the horizontal adjustment value a, so as to generate a horizontal coordinate value X_{E}−a of the patch point P₁. Besides, the processing unit 130 selects the vertical coordinate value Y_{E} of the latest touch point E according to the common stroke of “sideway”, and performs a subtraction operation on the vertical coordinate value Y_{E} and the vertical adjustment value b, so as to generate a vertical coordinate value Y_{E}−b of the patch point P₁. In the present embodiment, the horizontal adjustment value a and the vertical adjustment value b corresponding to the common stroke of “sideway” are, for example, respectively 20 and 30, though the invention is not limited thereto.

When the moving direction is the horizontal direction, the processing unit 130 determines that the specific stroke corresponding to the trajectory of the user's handwriting input is “bridle” or “horsewhip”, and FIG. 7 is a schematic diagram of patch points obtained when the trajectory of the touch corresponds to the common stroke of “bridle” or “horsewhip” according to an embodiment of the invention. The processing unit 130 obtains a horizontal adjustment value c and a vertical adjustment value c corresponding to the common stroke of “bridle” or “horsewhip”. As shown in FIG. 7, the processing unit 130 performs an addition operation on the horizontal coordinate value X_{S} of the initial touch point S and the horizontal adjustment value c to generate a horizontal coordinate value X_{S}+c of a first patch point P₁, and performs an addition operation on the vertical coordinate value Y_{S} of the initial touch point S and the vertical adjustment value c to generate a vertical coordinate value Y_{S}+c of the first patch point P₁. Moreover, the processing unit 130 performs an addition operation on the horizontal coordinate value X_{E} of the latest touch point E and the horizontal adjustment value c to generate a horizontal coordinate value X_{E}+c of a second patch point P₂, and performs an addition operation on the vertical coordinate value Y_{E} of the latest touch point E and the vertical adjustment value c to generate a vertical coordinate value Y_{E}+c of the second patch point P₂. Moreover, the processing unit 130 performs a subtraction operation on the horizontal coordinate value X_{E} of the latest touch point E and the horizontal adjustment value c to generate a horizontal coordinate value X_{E}−c of a third patch point P₃, and takes the vertical coordinate value Y_{E} of the latest touch pint E as a vertical coordinate value of the third patch point P₃. In addition, the processing unit 130 performs a subtraction operation on the horizontal coordinate value X_{E} of the latest touch point E and the horizontal adjustment value c to generate the horizontal coordinate value X_{E}−c of a fourth patch point P₄, and performs a subtraction operation on the vertical coordinate value Y_{E} of the latest touch point E and the vertical adjustment value c to generate a vertical coordinate value Y_{E}−c of the fourth patch point P₄. In the present embodiment, the horizontal adjustment value c and the vertical adjustment value c corresponding to the common stroke of “bridle” and “horsewhip” are, for example, all 15, though the invention is not limited thereto, and in other embodiment, the horizontal adjustment value and the vertical adjustment value may also have different values.

When the moving direction is the vertical direction, the processing unit 130 determines that the specific stroke corresponding to the trajectory of the user's handwriting input is “strive”, and FIG. 8 is a schematic diagram of patch points obtained when the trajectory of the touch corresponds to the common stroke of “strive” according to an embodiment of the invention. The processing unit 130 obtains a first horizontal adjustment value d, a second horizontal adjustment value f, a third horizontal adjustment value g, a first vertical adjustment value e and a second vertical adjustment value h corresponding to the common stroke of “strive”. As shown in FIG. 8, the processing unit 130 performs a subtraction operation on the horizontal coordinate value X_{S} of the initial touch point S and the first horizontal adjustment value d to generate a horizontal coordinate value X_{S}−d of the first patch point P₁, and performs a subtraction operation on the vertical coordinate value Y_{S} of the initial touch point S and the first vertical adjustment value e to generate a vertical coordinate value Y_{S}−e of the first patch point P₁. Moreover, the processing unit 130 performs a subtraction operation on the horizontal coordinate value X_{S} of the initial touch point S and the second horizontal adjustment value f to generate a horizontal coordinate value X_{S}−f of the second patch point P₂, and performs an addition operation on the vertical coordinate value Y_{S} of the initial touch point S and the first vertical adjustment value e to generate a vertical coordinate value Y_{S}+e of the second patch point P₂. The processing unit 130 performs a subtraction operation on the horizontal coordinate value X_{E} of the latest touch point E and the second horizontal adjustment value f to generate a horizontal coordinate value X_{E}−f of the third patch point P₃, and takes the vertical coordinate value Y_{E} of the latest touch point E as a vertical coordinate value of the third patch point P₃. The processing unit 130 performs a subtraction operation on the horizontal coordinate value X_{E} of the latest touch point E and the third horizontal adjustment value g to generate a horizontal coordinate value X_{E}−g of the fourth patch point P₄, and performs an addition operation on the vertical coordinate value Y_{E} of the latest touch point E and the second vertical adjustment value h to generate a vertical coordinate value Y_{E}+h of the fourth patch point P₄. In the present embodiment, the first horizontal adjustment value d corresponding to the common stroke of “strive” is, for example, 25, the second horizontal adjustment value f is, for example, 20, the third horizontal adjustment value g is, for example, 10, the first vertical adjustment value e is, for example, 10, and the second vertical adjustment value h is, for example, 15, though the invention is not limited thereto.

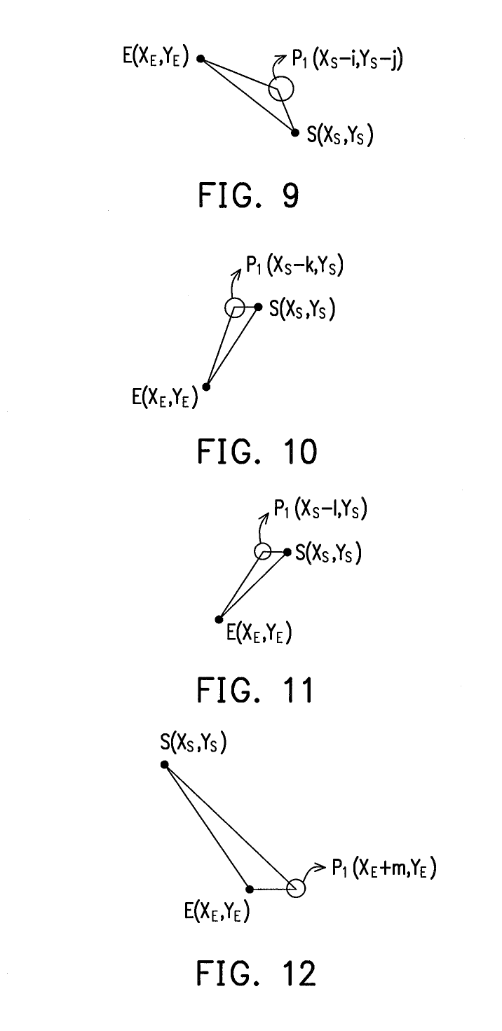

When the moving direction is the top left direction, the processing unit 130 determines that the specific stroke corresponding to the trajectory of the user's handwriting input is “jump”, and FIG. 9 is a schematic diagram of a patch point obtained when the trajectory of the touch corresponds to the common stroke of “jump” according to an embodiment of the invention. The processing unit 130 obtains a horizontal adjustment value i and a vertical adjustment value j corresponding to the common stroke of “jump”. As shown in FIG. 9, the processing unit 130 selects the horizontal coordinate value X_{S} of the initial touch point S according to the common stroke of “jump”, and performs a subtraction operation on the horizontal coordinate value X_{S} and the horizontal adjustment value i, so as to generate a horizontal coordinate value X_{S}−i of the patch point P₁. The processing unit 130 selects the vertical coordinate value Y_{S} of the initial touch point S according to the common stroke of “jump”, and performs a subtraction operation on the vertical coordinate value Y_{S} and the vertical adjustment value j, so as to generate a vertical coordinate value Y_{S}−j of the patch point P₁. In the present embodiment, the horizontal adjustment value i and the vertical adjustment value j corresponding to the common stroke of “jump” are, for example, respectively 20 and 40, though the invention is not limited thereto.

When the moving direction is the bottom left direction, and a distance between the initial touch point S and the latest touch point E is greater than the predetermined distance value, the processing unit 130 determines that the specific stroke corresponding to the trajectory of the user's handwriting input is “passing lightly”, and FIG. 10 is a schematic diagram of a patch point obtained when the trajectory of the touch corresponds to the common stroke of “passing lightly” according to an embodiment of the invention. The processing unit 130 obtains a horizontal adjustment value k and a vertical adjustment value k′ corresponding to the common stroke of “passing lightly”, and in the present embodiment, the vertical adjustment value k′ is 0. As shown in FIG. 10, the processing unit 130 selects the horizontal coordinate value X_{S} of the initial touch point S according to the common stroke of “passing lightly”, and performs a subtraction operation on the horizontal coordinate value X_{S} and the horizontal adjustment value k, so as to generate a horizontal coordinate value X_{S}−k of the patch point P₁. The processing unit 130 selects the vertical coordinate value Y_{S} of the initial touch point S according to the common stroke of “passing lightly”, and performs a subtraction operation on the vertical coordinate value Y_{S} and the vertical adjustment value k′, so as to generate a vertical coordinate value Y_{S}−k′ of the patch point P₁. Since the vertical adjustment value K′ is 0, in the present embodiment, the vertical coordinate value Y_{S}−k′ of the patch point P₁ is equal to the vertical coordinate value Y_{S} of the initial touch point S. In the present embodiment, the horizontal adjustment value k corresponding to the common stroke of “passing lightly” is, for example, 30, though the invention is not limited thereto.

When the moving direction is the bottom left direction, and a distance between the initial touch point S and the latest touch point E is smaller than or equal to the predetermined distance value, the processing unit 130 determines that the specific stroke corresponding to the trajectory of the user's handwriting input is “pecking”, and FIG. 11 is a schematic diagram of a patch point obtained when the trajectory of the touch corresponds to the common stroke of “pecking” according to an embodiment of the invention. The processing unit 130 obtains a horizontal adjustment value l and a vertical adjustment value l′ corresponding to the common stroke of “pecking”, and in the present embodiment, the vertical adjustment value l′ is 0. As shown in FIG. 11, the processing unit 130 selects the horizontal coordinate value X_{S} of the initial touch point S according to the common stroke of “pecking” and performs a subtraction operation on the horizontal coordinate value X_{S} and the horizontal adjustment value l, so as to generate a horizontal coordinate value X_{S}−l of the patch point P₁. The processing unit 130 selects the vertical coordinate value Y_{S} of the initial touch point S according to the common stroke of “pecking” and performs a subtraction operation on the vertical coordinate value Y_{S} and the vertical adjustment value l′, so as to generate a vertical coordinate value Y_{S}−l′ of the patch point P₁. Since the vertical adjustment value l′ is 0, in the present embodiment, the vertical coordinate value Y_{S}−l′ of the patch point P₁ is equal to the vertical coordinate value Y_{S} of the initial touch point S. In the present embodiment, the horizontal adjustment value l corresponding to the common stroke of “pecking” is, for example, 20, though the invention is not limited thereto.

When the moving direction is the bottom right direction, and a distance between the initial touch point S and the latest touch point E is greater than the predetermined distance value, the processing unit 130 determines that the specific stroke corresponding to the trajectory of the user's handwriting input is “dismemberment”, and FIG. 12 is a schematic diagram of a patch point obtained when the trajectory of the touch corresponds to the common stroke of “dismemberment” according to an embodiment of the invention. The processing unit 130 obtains a horizontal adjustment value m and a vertical adjustment value m′ corresponding to the common stroke of “dismemberment”, and in the present embodiment, the vertical adjustment value m′ is 0. As shown in FIG. 12, the processing unit 130 selects the horizontal coordinate value X_{E} of the latest touch point E according to the common stroke of “dismemberment” and performs an addition operation on the horizontal coordinate value X_{E} and the horizontal adjustment value m, so as to generate a horizontal coordinate value X_{E}+m of the patch point P₁. The processing unit 130 selects the vertical coordinate value Y_{E} of the latest touch point E according to the common stroke of “dismemberment” and performs an addition operation on the vertical coordinate value Y_{E} and the vertical adjustment value m′, so as to generate a vertical coordinate value Y_{E}+m′ of the patch point P₁. Since the vertical adjustment value m′ is 0, in the present embodiment, the vertical coordinate value Y_{E}+m′ of the patch point P₁ is equal to the vertical coordinate value Y_{E} of the latest touch point E. In the present embodiment, the horizontal adjustment value m corresponding to the common stroke of “dismemberment” is, for example, 40, though the invention is not limited thereto.

As shown in FIG. 6 to FIG. 12, the processing unit 130 can convert a line of the user's handwriting input into a closed polygon by adding the patch points (for example, connects the initial touch point, the latest touch point and all of the patch points according to a connecting sequence to form the closed polygon), so that the trajectory displayed on the display panel 123 is close to the common strokes defined by the Eight Principles of Yong. In an embodiment of the invention, the processing unit 130 fills the closed polygon with a color of the input character pre-selected by the user.

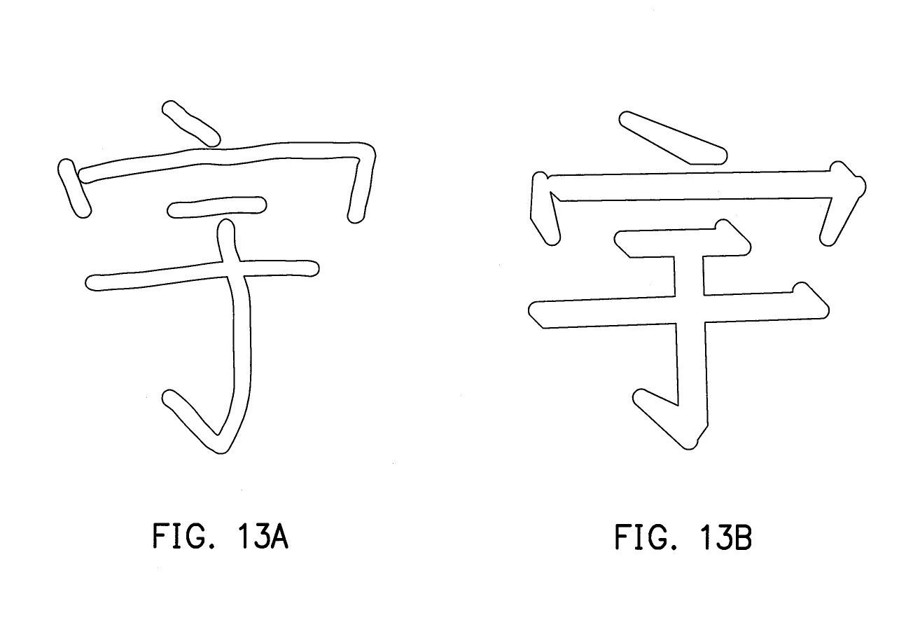

FIG. 13A is a schematic diagram of a trajectory of a handwriting input before adjustment according to an embodiment of the invention. FIG. 13B is a schematic diagram of a trajectory of a handwriting input after the aforementioned adjustment according to an embodiment of the invention. Referring to FIG. 13A and FIG. 13B, the input character is a traditional Chinese character “ [symbol] ” (pinyin: yu), it is discovered that based on the operation of the processing unit 130, the trajectory of the user's handwriting input has an appearance of the Regular script in Chinese, and presents an elegant handwriting input effect.

In summary, the stroke display method of handwriting input and the electronic device using the same of the invention can display the strokes of the user's handwriting input in a way consisting with the common strokes of a specific script style. In this way, when the user performs the handwriting input on the electronic device through the touch input module, the user can enjoy the beautified character while performing the input, so as to improve a fun of using the electronic device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A stroke display method of handwriting input, adapted to an electronic device having a touch input module and a display module, the stroke display method of handwriting input comprising:
receiving a selection of a specific script style, wherein the specific script style comprises a plurality of common strokes;
obtaining an initial touch point when a touch is detected by the touch input module;
continuously obtaining a latest touch point while the touch is not terminated, and determining a moving direction according to the initial touch point and the latest touch point;
once the touch is terminated or the moving direction is changed, determining whether a trajectory of the touch consists with a specific stroke in the common strokes according to the moving direction before changing;
if yes, determining at least one patch point according to the specific stroke, the initial touch point and the latest touch point; and
establishing a closed graph by using the initial touch point, the latest touch point, and the at least one patch point, and displaying the closed graph on the display module.

2. The stroke display method of handwriting input as claimed in claim 1, wherein the initial touch point and the latest touch point respectively comprise a horizontal coordinate value and a vertical coordinate value, and the step of determining the moving direction according to the initial touch point and the latest touch point comprises:
determining whether the moving direction is one of a plurality of preset directions according to a horizontal difference between individual horizontal coordinate values of the initial touch point and the latest touch point, a vertical difference between individual vertical coordinate values of the initial touch point and the latest touch point, and a slope between the initial touch point and the latest touch point.

3. The stroke display method of handwriting input as claimed in claim 2, wherein the step of determining whether the trajectory of the touch consists with the specific stroke in the common strokes according to the moving direction before changing comprises:
obtaining a corresponding relationship of the common strokes and the preset directions; and
determining the specific stroke according to the corresponding relationship when the moving direction before changing approaches to one of the preset directions.

4. The stroke display method of handwriting input as claimed in claim 2, wherein the step of determining the at least one patch point according to the specific stroke, the initial touch point and the latest touch point comprises:
obtaining a patch point template corresponding to each of the common strokes;
determining a number of the at least one patch point according to a shape of the patch point template corresponding to the specific stroke; and
calculating coordinate information of the at least one patch point according to the patch point template, and the horizontal coordinate values and the vertical coordinate values of the initial touch point and the latest touch point.

5. The stroke display method of handwriting input as claimed in claim 4, wherein the step of establishing the closed graph by using the initial touch point, the latest touch point, and the at least one patch point comprises:
connecting the initial touch point, the latest touch point and the at least one patch point as the closed graph consisting with the patch point template according to a connecting sequence.

6. The stroke display method of handwriting input as claimed in claim 2, wherein the preset directions comprise a vertical direction, a horizontal direction, a bottom left direction, a bottom right direction and a top left direction, and the step of determining whether the moving direction is one of the preset directions according to the horizontal difference, the vertical difference and the slope comprises:
determining the moving direction to be the vertical direction when the horizontal difference does not exceed an error range;
determining the moving direction to be the bottom left direction when the horizontal difference and the vertical difference all exceed the error range, the slope is smaller than a lower limit of a slope range, the horizontal coordinate value of the initial touch point is greater than the horizontal coordinate value of the latest touch point, and the vertical coordinate value of the initial touch point is smaller than or equal to the vertical coordinate value of the latest touch point;
determining the moving direction to be the bottom right direction when the horizontal difference and the vertical difference all exceed the error range, the slope is within the slope range, the horizontal coordinate value of the initial touch point is smaller than or equal to the horizontal coordinate value of the latest touch point, and the vertical coordinate value of the initial touch point is greater than the vertical coordinate value of the latest touch point;
determining the moving direction to be the top left direction when the horizontal difference and the vertical difference all exceed the error range, the slope is within the slope range, the horizontal coordinate value of the initial touch point is greater than the horizontal coordinate value of the latest touch point, and the vertical coordinate value of the initial touch point is smaller than or equal to the vertical coordinate value of the latest touch point; and
determining the moving direction to be the horizontal direction when the horizontal difference exceeds the error range and the vertical difference does not exceed the error range.

7. The stroke display method of handwriting input as claimed in claim 6, wherein the specific script style is a Regular script in Chinese, and the common strokes comprise “sideway”, “bridle”, “strive”, “jump”, “horsewhip”, “passing lightly”, “pecking” and “dismemberment” in the Eight Principles of Yong, and the step of determining whether the trajectory of the touch consists with the specific stroke in the common strokes according to the moving direction before changing comprises:
when the moving direction is the vertical direction, determining the corresponding specific stroke to be “strive”;
when the moving direction is the bottom left direction, determining the corresponding specific stroke to be “pecking” if a distance between the initial touch point and the latest touch point is smaller than or equal to a predetermined distance value, and determining the corresponding specific stroke to be “passing lightly” if the distance is greater than the predetermined distance value;
when the moving direction is the bottom right direction, determining the corresponding specific stroke to be “sideway” if the distance is smaller than or equal to the predetermined distance value, and determining the corresponding specific stroke to be “dismemberment” if the distance is greater than the predetermined distance value;
when the moving direction is the top left direction, determining the corresponding specific stroke to be “jump”; and
when the moving direction is the horizontal direction, determining the corresponding specific stroke to be “horsewhip” or “bridle”.

8. The stroke display method of handwriting input as claimed in claim 7, wherein the step of determining the at least one patch point according to the specific stroke, the initial touch point and the latest touch point comprises:
defining the at least one patch point to be a single patch point when the specific stroke is “passing lightly”, “pecking”, “dismemberment”, “sideway” or “jump”;
obtaining a horizontal adjustment value and a vertical adjustment value corresponding to the specific stroke;
selecting the horizontal coordinate value of the initial touch point or the horizontal coordinate value of the latest touch point according to the specific stroke to perform a first type arithmetic operation with the horizontal adjustment value, so as to generate a patch point horizontal coordinate value of the single patch point; and
selecting the vertical coordinate value of the initial touch point or the vertical coordinate value of the latest touch point according to the specific stroke to perform the first type arithmetic operation with the vertical adjustment value, so as to generate a patch point vertical coordinate value of the single patch point.

9. The stroke display method of handwriting input as claimed in claim 7, wherein the step of determining the at least one patch point according to the specific stroke, the initial touch point and the latest touch point comprises:
defining the at least one patch point to be a first patch point, a second patch point, a third patch point and a fourth patch point when the specific stroke is “horsewhip”, or “bridle”;
obtaining a horizontal adjustment value and a vertical adjustment value corresponding to the specific stroke;
performing a first type arithmetic operation on the horizontal coordinate value of the initial touch point and the horizontal adjustment value to generate a first patch point horizontal coordinate value of the first patch point, and performing the first type arithmetic operation on the vertical coordinate value of the initial touch point and the vertical adjustment value to generate a first patch point vertical coordinate value of the first patch point;
performing the first type arithmetic operation on the horizontal coordinate value of the latest touch point and the horizontal adjustment value to generate a second patch point horizontal coordinate value of the second patch point, and performing the first type arithmetic operation on the vertical coordinate value of the latest touch point and the vertical adjustment value to generate a second patch point vertical coordinate value of the second patch point;
performing a second type arithmetic operation on the horizontal coordinate value of the latest touch point and the horizontal adjustment value to generate a third patch point horizontal coordinate value of the third patch point, and taking the vertical coordinate value of the latest touch point as a third patch point vertical coordinate value of the third patch point; and
performing the second type arithmetic operation on the horizontal coordinate value of the latest touch point and the horizontal adjustment value to generate a fourth patch point horizontal coordinate value of the fourth patch point, and performing the second type arithmetic operation on the vertical coordinate value of the latest touch point and the vertical adjustment value to generate a fourth patch point vertical coordinate value of the fourth patch point.

10. The stroke display method of handwriting input as claimed in claim 7, wherein the step of determining the at least one patch point according to the specific stroke, the initial touch point and the latest touch point comprises:
defining the at least one patch point to be a first patch point, a second patch point, a third patch point and a fourth patch point when the specific stroke is “strive”;
obtaining a horizontal adjustment value, a second horizontal adjustment value, a third horizontal adjustment value, a first vertical adjustment value and a second vertical adjustment value corresponding to the specific stroke;
performing a second type arithmetic operation on the horizontal coordinate value of the initial touch point and the first horizontal adjustment value to generate a first patch point horizontal coordinate value of the first patch point, and performing the second type arithmetic operation on the vertical coordinate value of the initial touch point and the first vertical adjustment value to generate a first patch point vertical coordinate value of the first patch point;
performing the second type arithmetic operation on the horizontal coordinate value of the initial touch point and the second horizontal adjustment value to generate a second patch point horizontal coordinate value of the second patch point, and performing a first type arithmetic operation on the vertical coordinate value of the initial touch point and the first vertical adjustment value to generate a second patch point vertical coordinate value of the second patch point;
performing the second type arithmetic operation on the horizontal coordinate value of the latest touch point and the second horizontal adjustment value to generate a third patch point horizontal coordinate value of the third patch point, and taking the vertical coordinate value of the latest touch point as a third patch point vertical coordinate value of the third patch point; and
performing the second type arithmetic operation on the horizontal coordinate value of the latest touch point and the third horizontal adjustment value to generate a fourth patch point horizontal coordinate value of the fourth patch point, and performing the first type arithmetic operation on the vertical coordinate value of the latest touch point and the second vertical adjustment value to generate a fourth patch point vertical coordinate value of the fourth patch point.

11. An electronic device, comprising:
a touch input module, comprising:
a touch panel; and
a touch controller, coupled to the touch panel;
a display module, comprising:
a display panel; and
a display controller, coupled to the display panel; and
a processing unit, coupled to the touch controller and the display controller, wherein the processing unit receives a selection of a specific script style, and the specific script style comprises a plurality of common strokes,
when the touch panel detects a touch, the processing unit obtains a corresponding initial touch point through the touch controller, and continuously obtains a latest touch point while the touch is not terminated, and determines a moving direction according to the initial touch point and the latest touch point,
once the touch is terminated or the moving direction is changed, the processing unit determines whether a trajectory of the touch consists with a specific stroke in the common strokes according to the moving direction before changing,
if yes, the processing unit determines at least one patch point according to the specific stroke, the initial touch point and the latest touch point, and establishes a closed graph by using the initial touch point, the latest touch point, and the at least one patch point, and controls the display controller to display the closed graph on the display panel.

12. The electronic device as claimed in claim 11, wherein the initial touch point and the latest touch point respectively comprise a horizontal coordinate value and a vertical coordinate value, and the processing unit determines whether the moving direction is one of a plurality of preset directions according to a horizontal difference between individual horizontal coordinate values of the initial touch point and the latest touch point, a vertical difference between individual vertical coordinate values of the initial touch point and the latest touch point, and a slope between the initial touch point and the latest touch point.

13. The electronic device as claimed in claim 12, further comprising:
a storage unit, coupled to the processing unit, and recording a corresponding relationship of the common strokes and the preset directions,
wherein the processing unit obtains the corresponding relationship, and determines the specific stroke according to the corresponding relationship when the moving direction before changing approaches to one of the preset directions.

14. The electronic device as claimed in claim 12, wherein the storage unit records a patch point template corresponding to each of the common strokes,
the processing unit obtains the patch point template of the specific stroke, and determines a number of the at least one patch point according to a shape of the patch point template, and calculates coordinate information of the at least one patch point according to the patch point template, and the horizontal coordinate values and the vertical coordinate values of the initial touch point and the latest touch point.

15. The electronic device as claimed in claim 14, wherein the processing unit connects the initial touch point, the latest touch point and the at least one patch point as the closed graph consisting with the patch point template according to a connecting sequence.

16. The electronic device as claimed in claim 12, wherein the preset directions comprise a vertical direction, a horizontal direction, a bottom left direction, a bottom right direction and a top left direction,
the processing unit determines the moving direction to be the vertical direction when the horizontal difference does not exceed an error range,
the processing unit determines the moving direction to be the bottom left direction when the horizontal difference and the vertical difference all exceed the error range, the slope is smaller than a lower limit of a slope range, the horizontal coordinate value of the initial touch point is greater than the horizontal coordinate value of the latest touch point, and the vertical coordinate value of the initial touch point is smaller than or equal to the vertical coordinate value of the latest touch point;
the processing unit determines the moving direction to be the bottom right direction when the horizontal difference and the vertical difference all exceed the error range, the slope is within the slope range, the horizontal coordinate value of the initial touch point is smaller than or equal to the horizontal coordinate value of the latest touch point, and the vertical coordinate value of the initial touch point is greater than the vertical coordinate value of the latest touch point;
the processing unit determines the moving direction to be the top left direction when the horizontal difference and the vertical difference all exceed the error range, the slope is within the slope range, the horizontal coordinate value of the initial touch point is greater than the horizontal coordinate value of the latest touch point, and the vertical coordinate value of the initial touch point is smaller than or equal to the vertical coordinate value of the latest touch point; and
the processing unit determines the moving direction to be the horizontal direction when the horizontal difference exceeds the error range and the vertical difference does not exceed the error range.

17. The electronic device as claimed in claim 16, wherein the specific script style is a Regular script in Chinese, and the common strokes comprise “sideway”, “bridle”, “strive”, “jump”, “horsewhip”, “passing lightly”, “pecking” and “dismemberment” in the Eight Principles of Yong,
when the moving direction is the vertical direction. the processing unit determines the corresponding specific stroke to be “strive”,
when the moving direction is the bottom left direction, the processing unit determines the corresponding specific stroke to be “pecking” if a distance between the initial touch point and the latest touch point is smaller than or equal to a predetermined distance value, and determines the corresponding specific stroke to be “passing lightly” if the distance is greater than the predetermined distance value,
when the moving direction is the bottom right direction, the processing unit determines the corresponding specific stroke to be “sideway” if the distance is smaller than or equal to the predetermined distance value, and determines the corresponding specific stroke to be “dismemberment” if the distance is greater than the predetermined distance value,
when the moving direction is the top left direction, the processing unit determines the corresponding specific stroke to be “jump”, and
when the moving direction is the horizontal direction, the processing unit determines the corresponding specific stroke to be “horsewhip” or “bridle”.

18. The electronic device as claimed in claim 17, wherein the processing unit defines the at least one patch point to be a single patch point when the specific stroke is “passing lightly”, “pecking”, “dismemberment”, “sideway” or “jump”, obtains a horizontal adjustment value and a vertical adjustment value corresponding to the specific stroke, selects the horizontal coordinate value of the initial touch point or the horizontal coordinate value of the latest touch point according to the specific stroke to perform a first type arithmetic operation with the horizontal adjustment value, so as to generate a patch point horizontal coordinate value of the single patch point, and the processing unit selects the vertical coordinate value of the initial touch point or the vertical coordinate value of the latest touch point according to the specific stroke to perform the first type arithmetic operation with the vertical adjustment value, so as to generate a patch point vertical coordinate value of the single patch point.

19. The electronic device as claimed in claim 17, wherein the processing unit defines the at least one patch point to be a first patch point, a second patch point, a third patch point and a fourth patch point when the specific stroke is “horsewhip” or “bridle”, and obtains a horizontal adjustment value and a vertical adjustment value corresponding to the specific stroke,
the processing unit performs a first type arithmetic operation on the horizontal coordinate value of the initial touch point and the horizontal adjustment value to generate a first patch point horizontal coordinate value of the first patch point, and performs the first type arithmetic operation on the vertical coordinate value of the initial touch point and the vertical adjustment value to generate a first patch point vertical coordinate value of the first patch point,
the processing unit performs the first type arithmetic operation on the horizontal coordinate value of the latest touch point and the horizontal adjustment value to generate a second patch point horizontal coordinate value of the second patch point, and performs the first type arithmetic operation on the vertical coordinate value of the latest touch point and the vertical adjustment value to generate a second patch point vertical coordinate value of the second patch point,
the processing unit performs a second type arithmetic operation on the horizontal coordinate value of the latest touch point and the horizontal adjustment value to generate a third patch point horizontal coordinate value of the third patch point, and takes the vertical coordinate value of the latest touch point as a third patch point vertical coordinate value of the third patch point, and
the processing unit performs the second type arithmetic operation on the horizontal coordinate value of the latest touch point and the horizontal adjustment value to generate a fourth patch point horizontal coordinate value of the fourth patch point, and performs the second type arithmetic operation on the vertical coordinate value of the latest touch point and the vertical adjustment value to generate a fourth patch point vertical coordinate value of the fourth patch point.

20. The electronic device as claimed in claim 17, wherein the processing unit defines the at least one patch point to be a first patch point, a second patch point, a third patch point and a fourth patch point when the specific stroke is “strive”, and obtains a horizontal adjustment value, a second horizontal adjustment value, a third horizontal adjustment value, a first vertical adjustment value and a second vertical adjustment value corresponding to the specific stroke,
the processing unit performs a second type arithmetic operation on the horizontal coordinate value of the initial touch point and the first horizontal adjustment value to generate a first patch point horizontal coordinate value of the first patch point, and performs the second type arithmetic operation on the vertical coordinate value of the initial touch point and the first vertical adjustment value to generate a first patch point vertical coordinate value of the first patch point,
the processing unit performs the second type arithmetic operation on the horizontal coordinate value of the initial touch point and the second horizontal adjustment value to generate a second patch point horizontal coordinate value of the second patch point, and performs a first type arithmetic operation on the vertical coordinate value of the initial touch point and the first vertical adjustment value to generate a second patch point vertical coordinate value of the second patch point;
the processing unit performs the second type arithmetic operation on the horizontal coordinate value of the latest touch point and the second horizontal adjustment value to generate a third patch point horizontal coordinate value of the third patch point, and takes the vertical coordinate value of the latest touch point as a third patch point vertical coordinate value of the third patch point, and
the processing unit performs the second type arithmetic operation on the horizontal coordinate value of the latest touch point and the third horizontal adjustment value to generate a fourth patch point horizontal coordinate value of the fourth patch point, and performs the first type arithmetic operation on the vertical coordinate value of the latest touch point and the second vertical adjustment value to generate a fourth patch point vertical coordinate value of the fourth patch point.
